(19) United States
(12) Patent Application Publication
(10) Pub. No.: US 2025/0252866 A1
(43) Pub. Date: Aug. 7, 2025

(54) MOUTHPIECE FOR VOCALIZATION AND RESPIRATION TRAINING, AND VOCALIZATION TRAINING METHOD USING SAME

(71) Applicant: Kwan Hyun KIM, Seoul (KR)

(72) Inventor: Kwan Hyun KIM, Seoul (KR)

(21) Appl. No.: 18/701,099

(22) PCT Filed: Jan. 4, 2023
(86) PCT No.: PCT/KR2023/000126

§ 371 Date: Apr. 12, 2024

(30) Foreign Application Priority Data
Jan. 13, 2022 (KR) 10-2022-0005152

(51) Int. Cl. G09B 19/04; A63B 21/00; A63B 21/008; A63B 23/18

(52) U.S. Cl. CPC G09B 19/04; A63B 21/0083; A63B 21/4039; A63B 23/18

(57) ABSTRACT

The present invention discloses a mouthpiece for vocalization and respiration training including: a wing portion (110) extending to both sides of the cheeks, and configured to be flexibly bitten between the teeth and the lips; a front portion (120) configured such that a ventilation hole (121) is formed in the center of the wing portion (110) so that respiration is performed; labial frenulum protection portions (130) extending over and beneath the front portion (120), and protruding to come into contact with the labial frenula; and an extension portion (140) extending from the ventilation hole (121), and coupled to an air resistance regulator (200). In this case, in the state in which a specific amount of air is exhaled evenly through the air resistance regulator (200) and, at the same time, the oral cavity is filled with air and the cheeks are expanded, vocalization practice is performed.

### TECHNICAL FIELD

The present invention relates to a mouthpiece for vocalization and respiration training in which vocalization practice is performed, so that the throat is prevented from becoming narrowed or pressed, the area around the vocal cords or larynx is expanded and opened, loud sounds are produced without difficulty, vocal-cord and vowel sound vocalization is practiced, and the ability to produce high-pitched sounds is improved, and also relates to a vocalization training method using the same.

### BACKGROUND ART

As is well known, even when a user has natural talent for respiration and vocalization training, it is necessary to refine it through systematic education and improve the vocalization ability through voice therapy and practice over a long period of time.

Meanwhile, although a person wants to sing well, the vocal tract is narrowed, so that high-pitched sounds cannot be produced well, a pitch break occurs, the area around the neck becomes tense and thus tension is caused due to narrowing of the vocal tract, and vocal cords do not vibrate naturally due to excessive tension. Accordingly, the voice volume is low and loud sounds cannot be produced.

Furthermore, when the overall surface of the vocal cords is attached, the mass and volume become heavy so that it is impossible to produce high-pitched sounds and a pitch break phenomenon occurs. When a sound is produced by performing pushing with the force of a breath, the vocal cords will become tired and a person can no longer sing.

In relation to this, Korean Patent Application Publication No. 10-2331958 discloses a mouthpiece for vocalization and respiration training, which enables vocalization training to be performed. As shown in FIG. 1, the conventional mouthpiece for vocalization and respiration training includes: a mouthpiece body 110 formed in an arch-shaped structure having an open rear end, and provided with a ventilation hole formed in the front thereof; a pair of insertion holes 117 provided in the left and right inner sides of the mouthpiece body 110; and an elastic member 120 detachably fitted into the insertion holes 117, placed between the upper and lower teeth to prevent the mouthpiece body 110 from falling out of a user's mouth, configured to be contracted when the user applies pressure with the upper and lower teeth and to be returned to its original state when the pressure is released, thereby enabling various types of vocal respiration while opening and closing the mouth even in the state of wearing the mouthpiece body 110. Accordingly, vocal training is performed while moving the oral cavity using the elastic body 120.

However, due to the feeling of irritation caused by the elastic body 120, vomiting is easily caused when the mouthpiece is worn, thereby making it unsuitable for vocalization practice.

Therefore, there is a need for technology that enables a wearer to wear a mouthpiece for a long time without the feeling of irritation caused by a foreign object, allows the mouthpiece to be worn to fit a user's oral structure, and can protect the labial frenula.

### DISCLOSURE

### Technical Problem

A technical problem to be overcome by the spirit of the present invention is to provide a mouthpiece for vocalization and respiration training that makes it possible to wear the mouthpiece for a long time without the feeling of irritation caused by a foreign object, can be worn to fit a user's oral structure, and can protect the labial frenula, and also provide a vocalization training method using the same.

### Technical Solution

In order to accomplish the above object, an embodiment of the present invention provides a mouthpiece for vocalization and respiration training, the mouthpiece including: a wing portion extending to both sides of the cheeks, and configured to be flexibly bitten between the teeth and the lips; a front portion configured such that a ventilation hole is formed in the center of the wing portion so that respiration is performed; labial frenulum protection portions extending over and beneath the front portion, and protruding to come into contact with the labial frenula; and an extension portion extending from the ventilation hole and coupled to an air resistance regulator that adjusts air pressure according to exhalation.

In this case, each of the labial frenulum protection portions may be symmetrically inclined and also protrude from both sides thereof to the central area thereof.

Furthermore, the central area of each of the labial frenulum protection portions may be cut out in a valley form.

Furthermore, each of the labial frenulum protection portions may be segmentally formed to be folded in two or more stages toward the inside of the front portion.

Furthermore, the mouthpiece may further include cheek expansion portions extending from both sides of the extension portion to the wing portion and formed to come into contact with the insides of the cheeks and keep the expansion of the cheeks.

Furthermore, the outer peripheral edges of the wing portion are formed by being bent toward an inside of lips.

Meanwhile, another embodiment of the present invention provides a vocalization training method using a mouthpiece for vocalization and respiration training, the mouthpiece including: a wing portion extending to both sides of the cheeks, and configured to be flexibly bitten between the teeth and the lips; a front portion configured such that a ventilation hole is formed in the center of the wing portion so that respiration is performed; labial frenulum protection portions extending over and beneath the front portion, and protruding to come into contact with the labial frenula; an extension portion extending from the ventilation hole and coupled to an air resistance regulator that adjusts air pressure according to exhalation; and cheek expansion portions extending from both sides of the extension portion to the wing portion, and formed to come into contact with insides of the cheeks and keep the cheeks expanded, the vocalization training method including: a first step of wearing the mouthpiece for vocalization and expiration training to which the air resistance regulator is coupled; a second step of controlling air resistance according to exhalation by adjusting the air resistance regulator according to a user's lung capacity while wearing the mouthpiece for vocalization and respiration training; a third step of filling the oral cavity with air and keeping the cheeks expanded while allowing a specific amount of air to be discharged through the air resistance regulator when the user exhales; and a fourth step of practicing vocal-cord and vowel sound vocalization.

### Advantageous Effects

According to the present invention, in the state in which a specific amount of air is exhaled evenly through the air resistance regulator and, at the same time, the oral cavity is filled with air and the cheeks are expanded, vocalization practice is performed, so that the throat is prevented from becoming narrowed or pressed, the area around the vocal cords or larynx is expanded and opened, loud sounds are produced without difficulty, vocal-cord and vowel sound vocalization is practiced, and the ability to produce high-pitched sounds is improved.

### DESCRIPTION OF DRAWINGS

FIG. 1 illustrates a conventional mouthpiece for vocalization and respiration training;

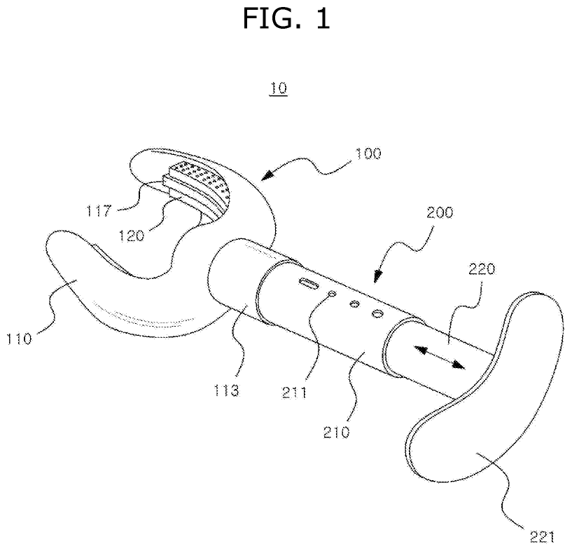

FIGS. 2A-2B are perspective views of a mouthpiece for vocalization and respiration training according to an embodiment of the present invention;

FIGS. 3A-3B are views showing a state in which the mouthpiece for vocalization and respiration training of FIGS. 2A-2B and an air resistance regulator are coupled to each other;

FIG. 4 shows front and side views of the labial frenulum protection portions of FIGS. 2A-2B;

FIGS. 5A-5B show a modification of the labial frenulum protection portions of FIGS. 2A-2B; and

FIG. 6 shows a flowchart of a vocalization training method using a mouthpiece for vocalization and respiration training according to another embodiment of the present invention.

### MODE FOR INVENTION

Hereinafter, embodiments of the present invention having the above-described features will be described in more detail with reference to the attached drawings.

A mouthpiece for vocalization and respiration training according to an embodiment of the present invention includes: a wing portion 110 extending to both sides of the cheeks, and configured to be flexibly bitten between the teeth and the lips; a front portion 120 configured such that a ventilation hole 121 is formed in the center of the wing portion 110 so that respiration is performed; labial frenulum protection portions 130 extending over and beneath the front portion 120, and protruding to come into contact with the labial frenula; and an extension portion 140 extending from the ventilation hole 121, and coupled to an air resistance regulator 200 that adjusts air pressure according to exhalation. In this case, in the state in which a specific amount of air is exhaled evenly through the air resistance regulator 200 and, at the same time, the oral cavity is filled with air and the cheeks are expanded, vocalization practice is performed, so that the throat is prevented from becoming narrowed or pressed, the area around the vocal cords of the throat or larynx is expanded and opened, loud sounds are produced without difficulty, vocal-cord and vowel sound vocalization is practiced, and the ability to produce high-pitched sounds is improved.

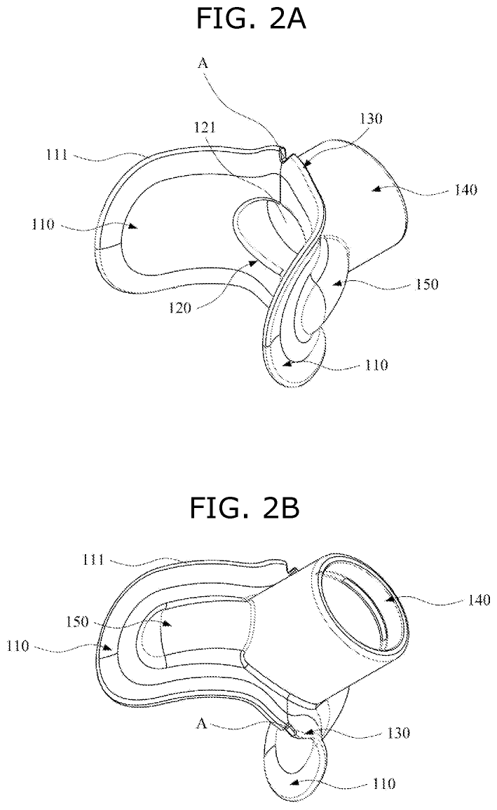

Hereinafter, the mouthpiece for vocalization and respiration training configured described above will be described in detail with reference to FIGS. 2A to 5B, as follows.

First, as shown in FIGS. 2A-2B, a wing portion 110 extends up to the inner sides of cheeks across both sides of the cheeks in a shape surrounding the cheeks, and both ends of the wing portion 110 are each finished in a round shape, so that it is flexibly bitten vertically between the opened teeth and the opened lips.

In this case, the width of the wing portion 110 extends to the molars on both sides of the cheeks, may be formed at a height that covers the open teeth and the open lips, is made of an eco-friendly soft material so that it can be flexibly bent according to the shape of the cheeks, and may be made of a transparent or translucent material so that the open state of the teeth or lips or a wearing state can be checked through a mirror or by a vocalization training instructor.

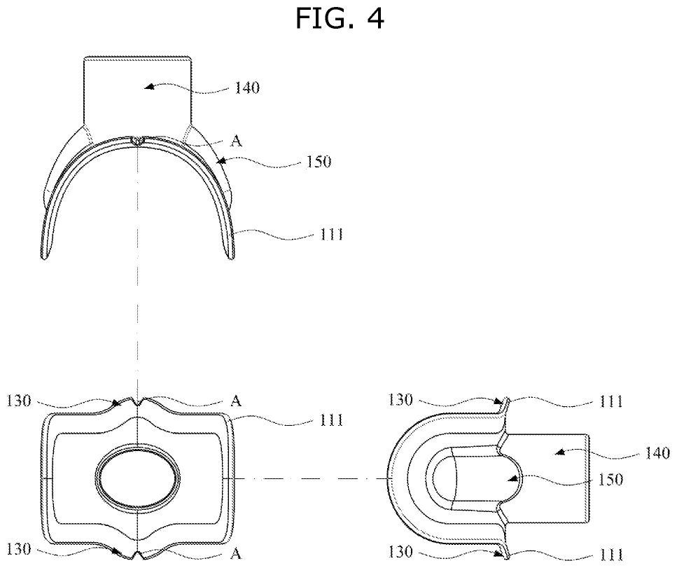

Furthermore, referring to FIGS. 2A-2B and 4, the outer peripheral edge 111 of the wing portion 110 is curved toward the insides of the lips and comes into close contact with the insides of the lips, thereby preventing the wing portion 110 from being easily separated during respiration or vocalization training.

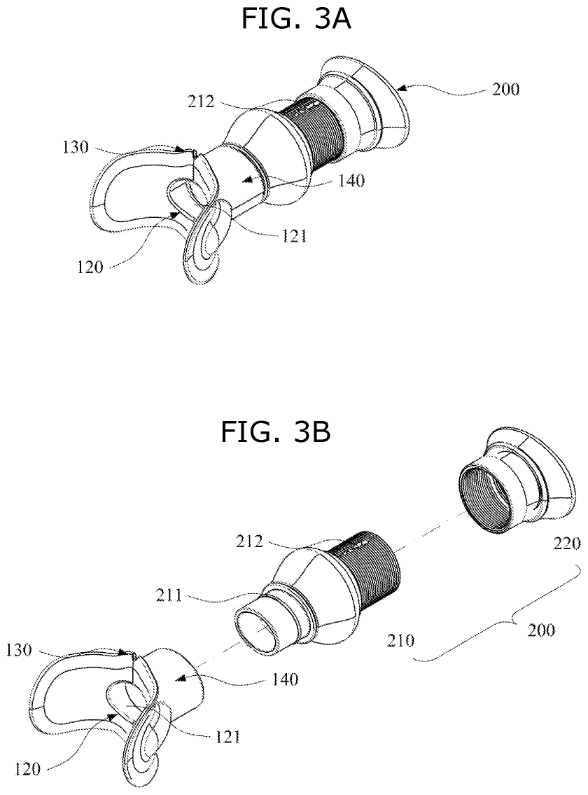

Next, as shown in FIGS. 2A-2B and 3A-3B, in a front portion 120, an oval-shaped ventilation hole 121 is formed through the center of the wing portion 110 to allow inhalation and exhalation to be performed.

Next, labial frenulum protection portions 130 extend over and beneath the front portion 120, and are curved and protrude to come into contact with the superior labial frenulum and the inferior labial frenulum, so that they protect the labial frenula while being worn tightly against the gums and the inside of the lips, as shown in FIGS. 2A-2B.

In this case, referring to FIG. 4, each of the labial frenulum protection portions 130 is symmetrically inclined and protrudes from both sides toward a central area A, so that the mouthpiece can be easily seated between the teeth and lips corresponding to the philtrum area, with the result that the mouthpiece is not separated during respiration or vocalization. The central area A of the labial frenulum protection portion 130 is cut smoothly out in a valley shape without any angles, so that the labial frenulum can be protected by a valley and can be prevented from being damaged.

Next, an extension portion 140 extends from the ventilation hole 121 and is coupled to an air resistance regulator 200 that adjusts air pressure according to exhalation.

For example, the air resistance regulator 200 may include: a coupling tube 210 that is inserted into the extension portion 140, is tightly coupled by a coupling ring 211, and has a plurality of air holes 212 formed in the longitudinal direction; and a piston 220 that is screwed into the coupling tube 210, and regulates air pressure by selectively opening and closing the air holes 212.

In this case, the plurality of air holes 212 are formed in a row in the direction from the extension portion 140 to the piston 220, and the holes are formed such that they sequentially increase in size to adjust the air pressure according to exhalation.

Meanwhile, referring to FIGS. 2A-2B and 4, there is further included cheek expansion portions 150 that extend from both sides of the extension portion 140 along the wing portion 110 and is formed to come into contact with the insides of the cheeks and keep the cheeks expanded when worn, so that vocalization training can be performed more easily in the state in which cheeks are expanded.

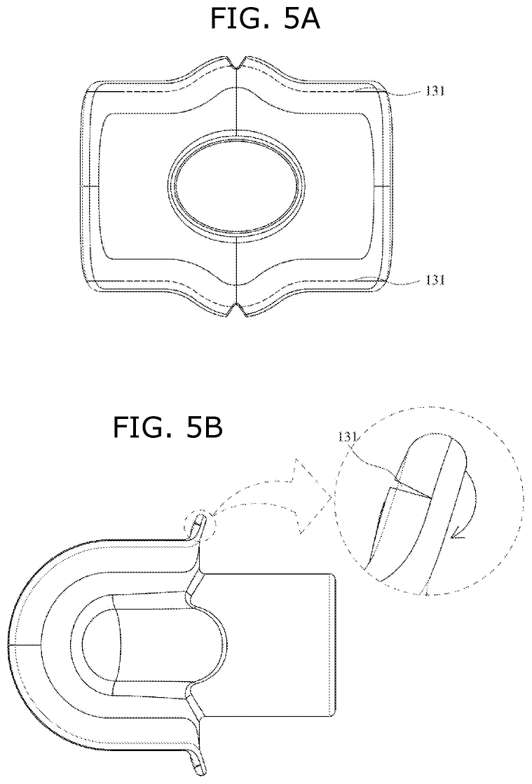

Meanwhile, FIGS. 5A-5B show a modification of the labial frenulum protection portions of FIGS. 2A-2B. Each of the labial frenulum protection portions 130 is segmentally formed to be folded in two or more stages toward the inside of the front portion 120 along a partially cut line 131 without blocking the ventilation hole 121. Accordingly, the height of the labial frenulum protection portions 130 may be varied according to the oral size of each user so that the mouthpiece can be worn easily.

For example, as shown as enlarged in FIG. 5B, the partially cut lines are formed by partial cutting to allow easy folding in the direction of the ventilation hole 121 (in the direction of the arrow). Accordingly, the upper and lower heights of the labial frenulum protection portions 130 can be adjusted and worn according to the oral sizes of people of all ages and genders.

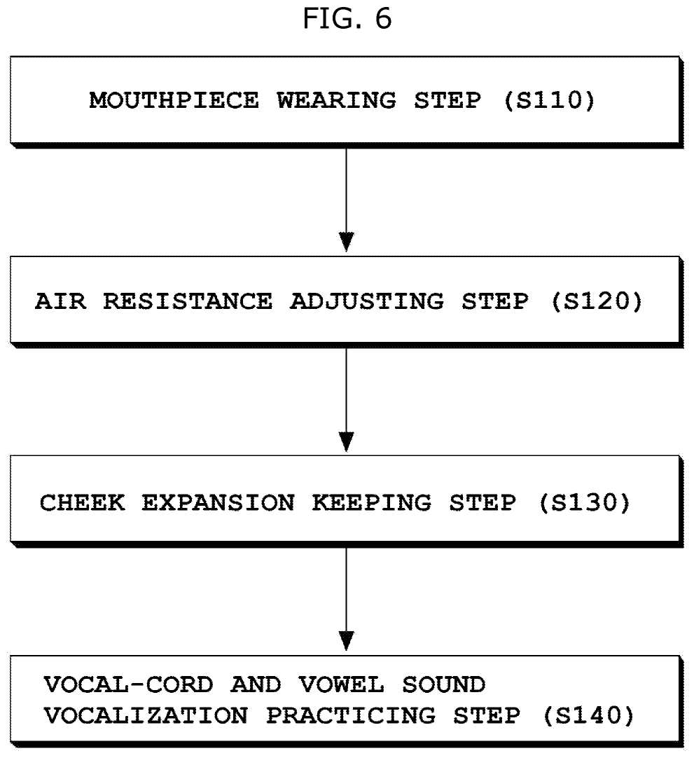

FIG. 6 shows a flowchart of a vocalization training method using a mouthpiece for vocalization and respiration training according to another embodiment of the present invention. The vocalization training method using the mouthpiece for vocalization and respiration training mentioned above is described in detail with reference to this drawing, as follows.

First, the mouthpiece for vocalization and respiration training may include: the wing portion 110 extending to both sides of the cheeks, and configured to be flexibly bitten between the teeth and the lips; the front portion 120 configured such that the ventilation hole 121 is formed in the center of the wing portion 110 so that respiration is performed; the labial frenulum protection portions 130 extending over and beneath the front portion 120, and protruding to come into contact with the labial frenula; the extension portion 140 extending from the ventilation hole 121, and coupled to the air resistance regulator 200 that adjusts air pressure according to exhalation; and the cheek expansion portions 150 extending from both sides of the extension portion 140 to the wing portion 110, and formed to come into contact with the insides of the cheeks and keep the cheeks expanded.

First, in a first step S110, the mouthpiece for vocalization and respiration training to which the air resistance regulator 200 is coupled is bitten and worn between the teeth and the lips.

Thereafter, in a second step S120, in the state in which the mouthpiece for vocalization training is worn, air resistance is adjusted according to exhalation by adjusting the air resistance regulator 200 according to a user's lung capacity.

For example, depending on the lung capacity, a user having a strong expiratory volume needs to adjust the air resistance regulator 200 to open the air holes 212 more, and a user having a weak expiratory volume may adjust the air hole 212 to increase resistance by closing the air holes 212 further.

Thereafter, in a third step S130, when a user exhales, the oral cavity is filled with air and the cheeks are kept expanded while a specific amount of air is discharged through the air resistance regulator 200.

In other words, when air is expelled during exhalation and hits the air resistance regulator 200, resistance is generated. In the case where force is applied to the lips holding the mouthpiece when pressure increases in the oral cavity, the effect cannot be achieved. It is important to prevent the pressure in the oral cavity from dropping only when a breath passes. Furthermore, both cheeks need to be kept fully expanded at all times.

In other words, when a wind is blown in the direction of the air resistance regulator 200 during exhalation and resistance is applied to the air resistance regulator 200, a specific amount of air is uniformly discharged out of the air resistance regulator 200, and at the same time, the oral cavity is filled with air and the cheeks are expanded. In this case, when the cheeks are not expanded, the oral cavity becomes narrowed and the larynx also becomes narrowed, so that the effect cannot be achieved. For vocalization training, a sound (a vocal-cord sound) needs to be produced at the same time that a breath is emitted. In other words, a sound (vocal-cord sound) needs to be produced at the same time that exhalation is performed.

Meanwhile, it is necessary to prevent a case where only a breath is emitted and no sound is produced, or a case where only a sound is heard, the amount of exhalation decreases, the pressure drops, and the expansion of the cheeks decreases. Furthermore, a sound needs to be emitted regularly, and the uniform amount and sound of exhalation need to be kept. In order to prevent the pressure in the oral cavity from dropping, the pressure at which the cheeks are expanded needs to be kept by continuously maintaining the expiratory speed and expiratory volume so that breath hits the air resistance regulator 200. In this case, the air resistance regulator 200 generates resistance and thus generates pressure, which was previously absent, from the vocal cords to the oral cavity, thereby inducing the vibration of the vocal cords and lowering the vocal cord threshold to facilitate vocal-cord vibration, which can help to improve a vocalization function.

Thereafter, in a fourth step S140, training is performed to prevent the throat from being narrowed, vocal cord sounds are practiced, high-pitched sounds are practiced, or the vowel sound vocalization of ‘ah, eh, ee, oo, woo’ are practiced.

First, a training method for preventing the neck from being narrowed is illustrated as follows.

When chest sounds are practiced using voice, the cheeks are expanded by producing sound while passing air through the vocal cords. In this case, in the case where the size of the cheeks is reduced when making continuing vocalization sounds, the vocalization effect cannot be achieved.

Accordingly, when a breath passes through the vocal cords and the oral cavity and reaches the mouthpiece, resistance is generated by the air resistance regulator 200 and thus the pressure in the oral cavity increases because the mouthpiece is blocking the mouth. When the cheeks are kept expanded, the pressure inside the throat increases, so that the throat and the larynx expand and the vocal tract becomes widened. Accordingly, the surrounding muscle tissue that tightens the vocal cords is widened, which forcibly removes the narrowing of the throat.

Accordingly, when vocalization is performed using the above-described mouthpiece as descried above, the throat is forcibly opened to produce sounds. Meanwhile, vocalization needs to produce sounds according to Bernoulli's law. When the throat becomes narrowed, the natural laws of the vocal cords are broken and the vocal cords are pressed down, thereby making it impossible to produce normal sounds. Since performing vocalization while simply blowing into the mouthpiece with exhalation can actually narrow the throat, the effect is achieved only when vocalization is performed using the above-described method.

In addition, when a high-pitched sound is produced, the throat becomes tightened, so that a sound is not produced and constriction is caused, which causes the phenomenon of being out of tune and the phenomenon of putting pressure on the throat. In this case, the pressure in the mouth needs to be increased by increasing air resistance, the amount of expiratory air coming out through the mouthpiece needs to be kept constant, so that the cheeks need to be kept expanded. In other words, when a sound is produced, the cheeks and the area under the chin are expanded together and the larynx is expanded, so that excessive tension on the vocal cords is reduced, the vibration of the vocal cords is smoothly performed, and practice is performed to prevent the neck from being tightened or pressed or prevent sound from being out of tune.

Second, a training method for practicing high-pitched sounds is illustrated as follows.

In order to practice high-pitched sounds, it is necessary to practice continuing a vocal-cord v sound by breathing out from the neutrophils during exhalation first and then closing the vocal cords within 1 to 2 seconds. In this case, no force needs to be applied to purse the lips, and pressure needs to be kept and increased in the oral cavity to keep both cheeks fully expanded.

Meanwhile, it is necessary to avoid making a thick, deep voice. When a higher pitch is reached, it is necessary to gradually shorten the time for which a user closes the vocal cords after exhalation to make a sound, and practice closing the vocal cords momentarily and then continuing the sound. In this case, as a sound becomes high-pitched, the air resistance of the air resistance regulator 200 increases and the pressure in the oral cavity increases. According to the principle of transglottal pressure, when the mouth is opened to make a sound without a mouthpiece, there is no supraglottic pressure because atmospheric pressure and oral pressure are equal to each other. As air resistance is generated by the air resistance regulator 200 and oral pressure increases, supraglottic pressure increases, so that the vocal cords are caused to tremble, thereby increasing the vibration frequency of the vocal cords and producing a high-pitched sound.

Third, a method for practicing the vowel sound vocalization of ‘ah, eh, ee, oo, woo’ is illustrated as follows.

In the state of wearing the mouthpiece according to the present embodiment, it may be possible to practice the vocalization of “ah, eh, ee, oo, woo” by moving the mouth up and down and opening and closing the teeth accordingly.

For example, it may be possible to practice the vocalization of “ah” and “oh” by opening the teeth, it may be possible to practice the vocalization pf “u” by opening the teeth halfway, and it may be possible to practice the vocalization of “eh” and “ii” by opening the teeth slightly.

Meanwhile, even when pronunciation is changed by moving the teeth in vocalization, the expiratory volume always needs to be blown uniformly in the direction of the mouthpiece to prevent the oral pressure and cheek expansion pressure from decreasing. People having weak expiratory ability may increase air resistance by blocking the air holes 212 of the air resistance regulator 200, and people having strong expiratory ability may lower air resistance by opening the air holes 212 more.

Accordingly, as in lip trill or humming that practices vocalization using the semi-occluded vocal tract exercise (SOVTE) by always closing the mouth, vocalization practice using slight oral pressure due to small resistance is performed using the mouthpiece for vocalization and respiration training according to the present embodiment and the vocalization training method using the same. In this case, even with the mouth open, oral pressure is generated using the air resistance of the air resistance regulator 200, so that it is easy to perform training to prevent the throat from being narrowed, to practice high-pitched sounds, or to practice the vowel sound vocalization of ‘ah, eh, ee, oo, woo.’

Meanwhile, without the mouthpiece for vocalization and respiration training mentioned above, only the air resistance regulator 200 is bitten between the lips, the air resistance according to exhalation is adjusted, and then a specific amount of air is discharged. Training is performed to prevent the neck from being narrowed by filling the mouth with air and keeping the cheeks expanded. Vocal sounds are practiced, high-pitched sounds are practiced, or the vowel sound vocalization of ‘ah, eh, ee, oo, woo’ is practiced. Accordingly, similar effects to those of vocalization or respiration practice using the mouthpiece for vocalization and respiration training are also achieved.

Therefore, according to the mouthpiece for vocalization and respiration training and the vocalization training method using the same as described above, in the state in which a specific amount of air is exhaled evenly through the air resistance regulator and, at the same time, the oral cavity is filled with air and the cheeks are expanded, vocalization practice is performed, so that the throat is prevented from becoming narrowed or pressed, the area around the vocal cords or larynx is expanded and opened, loud sounds are produced without difficulty, vocal-cord and vowel sound vocalization is practiced, and the ability to produce high-pitched sounds is improved.

The embodiments described in the present specification and the configurations shown in the drawings are only the most preferred embodiments of the present invention and do not represent the overall technical spirit of the present invention. Therefore, it should be understood that at the time when the present application is filed, there may be various equivalents and modifications that can replace them.

1. A mouthpiece for vocalization and respiration training, the mouthpiece comprising:
a wing portion extending to both sides of cheeks, and configured to be flexibly bitten between teeth and lips;
a front portion configured such that a ventilation hole is formed in a center of the wing portion so that respiration is performed;
labial frenulum protection portions extending over and beneath the front portion, and protruding to come into contact with labial frenula; and
an extension portion extending from the ventilation hole and coupled to an air resistance regulator that adjusts air pressure according to exhalation.

2. The mouthpiece of claim 1, wherein each of the labial frenulum protection portions is symmetrically inclined and also protrude from both sides thereof to a central area thereof.

3. The mouthpiece of claim 2, wherein the central area of each of the labial frenulum protection portions is cut out in a valley form.

4. The mouthpiece of claim 1, wherein each of the labial frenulum protection portions is segmentally formed to be folded in two or more stages toward an inside of the front portion.

5. The mouthpiece of claim 1, further comprising cheek expansion portions extending from both sides of the extension portion to the wing portion and formed to come into contact with insides of the cheeks and keep the expansion of the cheeks.

6. The mouthpiece of claim 1, wherein outer peripheral edges of the wing portion are formed by being bent toward an inside of lips.

7. A vocalization training method using a mouthpiece for vocalization and respiration training, the mouthpiece including: a wing portion extending to both sides of cheeks, and configured to be flexibly bitten between teeth and lips; a front portion configured such that a ventilation hole is formed in a center of the wing portion so that respiration is performed; labial frenulum protection portions extending over and beneath the front portion, and protruding to come into contact with labial frenula; an extension portion extending from the ventilation hole and coupled to an air resistance regulator that adjusts air pressure according to exhalation; and cheek expansion portions extending from both sides of the extension portion to the wing portion, and formed to come into contact with insides of the cheeks and keep the cheeks expanded, the vocalization training method comprising:
a first step of wearing the mouthpiece for vocalization and expiration training to which the air resistance regulator is coupled;
a second step of controlling air resistance according to exhalation by adjusting the air resistance regulator according to a user's lung capacity while wearing the mouthpiece for vocalization and respiration training;
a third step of filling an oral cavity with air and keeping the cheeks expanded while allowing a specific amount of air to be discharged through the air resistance regulator when the user exhales; and
a fourth step of practicing vocal-cord and vowel sound vocalization.
